(19) United States
(12) Patent Application Publication
(10) Pub. No.: US 2015/0186923 A1
(43) Pub. Date: Jul. 2, 2015

(54) SYSTEMS AND METHODS TO MEASURE MARKETING CROSS-BRAND IMPACT USING NEUROLOGICAL DATA

(71) Applicants: Ramachandran Gurumoorthy, Berkeley, CA (US); Robert T. Knight, Berkeley, CA (US)

(72) Inventors: Ramachandran Gurumoorthy, Berkeley, CA (US); Robert T. Knight, Berkeley, CA (US)

(21) Appl. No.: 14/144,960

(22) Filed: Dec. 31, 2013

(51) Int. Cl. G06Q 30/02

(52) U.S. Cl. CPC G06Q 30/0242; G06Q 30/0243

(57) ABSTRACT

Example systems and methods to measure marketing cross-brand impact using neurological data are disclosed. An example method includes accessing first neuro-response data obtained from a subject prior to exposure to a first stimulus having a first component, second neuro-response data obtained from the subject after exposure to the first stimulus and prior to exposure to a second stimulus, third neuro-response data obtained from the subject after exposure to the second stimulus, and fourth neuro-response data obtained from the subject after exposure to a third stimulus having the first component. The example method also includes determining, using a processor, a change in a subject resonance to the first component based on a comparison of a first difference between the first neuro-response data and the second neuro-response data relative to a second difference between the third neuro-response data and the fourth neuro-response data.

### FIELD OF THE DISCLOSURE

This disclosure relates generally to advertising, and, more particularly, to systems and methods to measure marketing cross-brand impact using neurological data.

### BACKGROUND

A company may have a portfolio of brands, including a master brand and one or more sub-brands associated with the master brand. An advertising campaign directed toward a sub-brand may affect a consumer's perception of the master brand. Similarly, brand advertising campaigns may affect the consumer's perception of a competitor brand. Prior methods of determining a change in a consumer's perception rely on articulated responses from the consumer collected, for instance, via surveys.

### BRIEF DESCRIPTION OF THE DRAWINGS

FIG. 1 is a schematic illustration of example cross-brand and/or competitor brand relationships.

FIG. 2 is a schematic illustration of an example system constructed in accordance with the teachings of this disclosure to measure marketing cross-brand impact using neurological data.

FIG. 3 is an illustration of an example process for obtaining neurological data to measure cross-brand market impact using the example system of FIG. 2.

FIG. 4 is an illustration of an example event related potential waveform in connection with the example process of FIG. 3.

FIG. 5 is a flow chart representative of example machine readable instructions that may be executed to implement the example system of FIG. 2.

FIG. 6 is a diagram of an example processor platform which may execute the example instructions of FIG. 5 to implement the example system of FIG. 2.

### DETAILED DESCRIPTION

Example systems and methods to measure marketing cross-brand impact based on neurological response data are disclosed. An entity may own a brand portfolio (e.g., a total collection trademarks or services marks that an entity applies to its products or services), which may include a master brand and one or more sub-brand(s) that are associated with the master brand. The association between the master brand and the one or more sub-brands may be based on one or more shared attributes, such as ownership and/or product or service characteristics. For example, The Coca-Cola Company owns Coca-Cola® (e.g., a master brand), which is associated with various sub-brands related to soft drinks, including Diet Coke® and Sprite®, as well as other types of drinks owned by The Coca-Cola Company, including Dasani® (bottled water) and Powerade® (sports drinks). The collection of the brands CocaCola®, Diet Coke®, Sprite®, Dasani®, and Powerade® along with the other brands owned by The Coca-Cola Company make up The Coca-Cola Company's brand portfolio. Similarly, a marketplace competitor to The Coca-Cola Company, such as PepsiCo, may also own a brand portfolio including one or more master brands (e.g., Pepsi®), as well as various sub-brands (e.g., Diet Pepsi® and Gatorade®).

In the marketplace, consumers encounter one or more of the master brands and/or the sub-brands of a brand portfolio. In encountering a brand, consumers form one or more perceptions of the brand based on, for example, product attributes, service attributes, quality, packaging, pricing, advertising, etc. Consumer master brand and/or sub-brand perceptions may be associated with, for example, attention, emotional engagement, memory, awareness, favorable/unfavorable impression, etc. of the one or more brands in the portfolio. As used herein, “attention” is a measure of sustained focus and/or shift(s) in focus over time. As used herein, “emotional engagement” is a measure of intensity of emotional response and automatic emotional classification of stimuli. As used herein, “memory” is a measure of a formation of connections and/or retention. In this context, the connections can be explicit (e.g., readily recalled) or implicit. Also, consumer brand perceptions may reflect a resonance and/or an association of a master brand and/or a sub-brand with one or more concepts in the mind of the consumer, such as, for example, an association between (1) the master brand and/or the sub-brand and (2) the concepts of “healthy” or “fun.” As used herein, “resonance” is a measure of a quality (e.g., positive, negative, etc.) and/or degrees of evoked response.

In some instances, the consumer forms perceptions about the master brand and/or the sub-brands in relation to other master brands and/or sub-brands in the brand portfolio. An entity that owns a brand portfolio may selectively advertise (e.g., through a marketing campaign) for one or more of the master brands and/or the sub-brands in the portfolio. However, because of the associations between the master brands and/or the sub-brands in the portfolio, and in light of a consumer's exposure to the advertising as well as the other master brands and/or sub-brands in the portfolio, marketing targeted toward, for example, a first sub-brand (e.g., Diet Coke®) can intentionally or unintentionally affect the consumer's perceptions of the other master brands and/or sub-brands in the portfolio (e.g., Coca-Cola®, Sprite®), thereby resulting in a marketing cross-brand impact.

For example, a consumer may have a perception of the master brand Coca-Cola® (e.g., as being associated with unhealthy soft drinks). The Coca-Cola Company may provide an advertising campaign for the sub-brand Coke Zero®. After exposure to, for example, an advertisement for Coca-Cola Zero®, the consumer's perception of the master brand Coca-Cola® may change. For example, the consumer may be more likely to associate Coca-Cola® with the concept of “healthy” after viewing the advertisement for Coca-Cola Zero®, which the consumer may consider to be a more health-conscious choice provided by The Coca-Cola Company. Such an example may be representative of a marketing cross-brand impact, which may include an effect of marketing related to a sub-brand (e.g., Coca-Cola Zero®) on a consumer's perceptions of a master brand (e.g., Coca-Cola®).

The impact of the sub-brand marketing on the consumer's perceptions of the master brand can be intended (e.g., to increase the consumer's association of the master brand with the concept of “fun” based on an advertisement for a sub-brand of alcohol in connection with a party) or unintended (e.g., having the effect of the consumer viewing the master brand as being associated with promotion of risky behavior). An entity may be interested in measuring the impact of the sub-brand marketing on the sub-brand as well as on the master brand. Additionally or alternatively, an entity may be interested in measuring the impact of the sub-brand marketing on the consumer's perceptions of a competitor's brand and/or a competitor's sub-brand. Information about the sub-brand marketing may additionally or alternatively be used, for example, in determining whether an advertising campaign is meeting objectives related to the sub-brand while not negatively impacting one or more brands in a portfolio owned by the entity associated with the sub-brand.

Conventional assessments of marketing impact provide measures directed toward the brand for which the marketing is associated but are inadequate for identifying consumer perceptions to, for example, a master brand as a result of sub-brand advertising. Consumer data collected, for example, via surveys, in response to an advertisement for a sub-brand may reflect a change in a consumer's perceptions of the sub-brand after viewing the advertisement. In other examples, to assess the impact of the advertisement for the sub-brand on a master brand and/or one or more other sub-brand(s) in a portfolio of brands, multiple tests are performed to obtain a consumer's perceptions of the master brand and/or the one or more other sub-brand(s) of the portfolio, and the sub-brand associated with the advertisement. However, performing multiple and/or separate tests with respect to the impact of the sub-brand advertisement on the master brand and the sub-brand is a piecemeal approach to assessing the extent of the impact of the sub-brand advertisement. Further, this piecemeal approach may not capture implicit perceptions of the master brand in view of the sub-brand advertisement and/or attributes of the sub-brand. Also, survey results provide only limited, and sometimes inaccurate, information about a consumer's perceptions due to, for example, faulty memories, dishonest responses, prior survey response biases, and/or inarticulate consumers.

Examples disclosed herein provide techniques for a cross-brand impact measurement for evaluating the effects of advertising for a sub-brand on the sub-brand and an associated brand, such as, for example, a master brand, a competitor brand, and/or one or more other master brands and/or sub-brands. The impacted master brand(s) and/or sub-brand(s) may be in a same portfolio and/or in different portfolios. Examples disclosed herein also provide for the evaluation of the effects of the sub-brand itself on the associated mater brand, competitor brand, and/or other sub-brands. In some examples disclosed herein, neuro-response data is collected (1) before and after a consumer is exposed to a master brand, but before the consumer is exposed to a sub-brand of interest; (2) after exposure of the consumer to the sub-brand; and (3) after the consumer is re-exposed to the master brand and/or is exposed to a brand sharing an attribute with the master brand (e.g., a competitor brand), and after being exposed to the sub-brand. The exposure to the sub-brand may be, for example, in an advertisement for the sub-brand, via exposure to a specimen of the sub-brand (e.g., a physical product or package), or otherwise. Resonance measures for the exposure to the sub-brand with respect to the consumer's perceptions of the sub-brand are determined. For example, comparisons of the neurological data obtained prior to and after exposure to the sub-brand and in view of exposure to the master brand provide for evaluation of the impact of the sub-brand on the consumer's perceptions of the master brand. Such evaluations allow, for example, an entity to evaluate the effectiveness of the objectives of the sub-brand marketing campaign on the consumer's implicit perceptions of the sub-brand and/or the sub-brand attributes. Additionally or alternatively, such evaluations allow the entity to assess intentional and/or unintentional effects of the sub-brand campaign on the consumer's implicit perceptions of the master brand based on an analysis of the consumer's neurological responses to the sub-brand and the master brand. In some examples, the analysis is performed in view of one or more brand(s) of one or more portfolios of brands, a competitor master brand, and/or a competitor sub-brand.

In some examples disclosed herein, neuro-response data collected from the consumer pre- and post-exposure to the sub-brand advertisement and/or pre- and post-exposure to the sub-brand, another sub-brand, and/or the master brand for which the impact of the sub-brand advertisement is of interest is accessed and analyzed to derive event related potential (ERP) measurements. ERP measurements are time-locked, signal-averaged electroencephalography (EEG) recordings for multiple trials involving a cognitive trigger event. ERP measurements reflect brain activity associated with mental operations in response to the event (e.g., exposure to a stimulus, which may include, for example, exposure to a product, an advertisement, entertainment and/or other material(s) to stimulate one or more sense(s)). ERPs are measured using, for example, EEG, which records the electrical activity of the brain. As a subject is exposed to a stimulus, the resulting brain activity is measured over a period of time and/or trials. The averaged EEG data may be represented as a waveform that represents the ERP. The waveform includes positive and negative components (e.g., voltage deflections) that may be further analyzed to evaluate cognitive brain function. Analysis techniques involving peak amplitude, average amplitude, peak aligned average amplitude, latency of response, spectral content of response, and/or area under the curve (e.g., mathematical integration) may be employed to detect ERP components associated with cognitive brain function. For example, one ERP component is the P300 wave component that is represented by a positive deflection in voltage with a latency between 250 to 500 milliseconds from the presentation of the stimulus and is typically associated with decision making. Other examples are provided below.

ERP measurements may be further analyzed to determine a subject resonance to a stimulus. ERP measurements can be derived from neuro-response data collected prior to and after exposure to the stimulus. Calculating the differential between pre-stimulus ERP measurements and post-stimulus ERP measurements (e.g., waveform amplitude differences) results in a differential event related potential (DERP) measurement. The DERP measurement reflects the subject's response to the stimulus. The DERP measurement may be placed on a relative scale and may indicate a degree of resonance (e.g., an evoked response) to the stimulus. For example, as provided in greater detail below, the DERP measurement may be converted to a number on a scale of, for example, 1-10 in which 1 represents a response of lower resonance and 10 represents a response of greater resonance.

In some examples disclosed herein, a subject is exposed to a master brand, then a sub-brand, and then the master brand again. In some such examples, a first DERP measurement is calculated, for example, by subtracting (1) a first ERP based on the neuro-response data obtained pre-exposure to the master brand and pre-exposure to the sub-brand from (2) a second ERP based on the neuro-response data obtained post-exposure to the master brand and pre-exposure to the sub-brand. A second DERP measurement is calculated, for example, by subtracting (1) a third ERP based on the neuro-response data obtained post-exposure to the sub-brand, but before re-exposure (e.g., before a second exposure) to the master brand from (2) a fourth ERP based on the neuro-response data obtained post-exposure to the sub-brand and after re-exposure (e.g., after a second exposure) to the master brand and/or after exposure to a brand sharing an attribute with the master brand.

In some examples, a change in subject resonance to the master brand as a result of exposure to the sub-brand is determined based on the DERP measurements. For example, the first DERP measurement of the above example reflects the subject's evoked response to exposure to the master brand (e.g., the subject's perception of the master brand) prior to exposure to the sub-brand. The second DERP measurement in this example reflects the subject resonance to the master brand after exposure to the sub-brand. In this example, a comparison of the first DERP measurement (e.g., reflecting subject resonance to the master brand and calculated prior to exposure to the sub-brand) and the second DERP measurement (e.g., reflecting subject resonance to the master brand and calculated after exposure to the sub-brand) reflects the change in the subject resonance to the master brand as a result of exposure to the sub-brand.

A change in the subject resonance to the master brand pre- and post-exposure to the sub-brand is representative of the impact of the sub-brand and/or the sub-brand marketing on the consumer's perception of the master brand. For example, an increase in subject resonance to the master brand post-exposure to the sub-brand (e.g., the value of the second DERP measurement, which may be, for example, an 8 on the 1-to-10 scale) as compared to the subject resonance to the master brand prior to exposure to the sub-brand (e.g., the value of the first DERP measurement, which may be for, example, a 5 on the 1-to-10 scale) indicates that the sub-brand is effective in increasing implicit consumer perceptions (e.g., awareness, association with certain concepts, favorable impression, etc.) of the master brand. A decrease in subject resonance to the master brand post-exposure to the sub-brand as determined by comparing the values of the first and second DERP measurements (e.g., where the first DERP is a 5 and the second DERP is a 3) indicates that the sub-brand had, for example, an unintended result of giving a consumer a less favorable perception of the master brand than held by the consumer prior to exposure to the sub-brand.

In some examples, the subject resonance to the sub-brand is determined using the neuro-response data collected prior to exposure to the sub-brand and prior to re-exposure to the master brand after exposure to the sub-brand. A third DERP measurement is calculated, for example, by subtracting (1) the second ERP, which is based on the neuro-response data obtained post-exposure to the master brand and pre-exposure to the sub-brand from (2) the third ERP, which is based on the neuro-response data obtained post-exposure to the sub-brand, but before re-exposure to the master brand. The third DERP of this example reflects the subject resonance or evoked response to the sub-brand and provides an indication of the effectiveness of the sub-brand in communicating certain concepts (e.g., “healthy” or “fun”) to the subject.

Some example methods disclosed herein include accessing first neuro-response data obtained from a subject prior to exposure to a first stimulus (e.g., an advertisement, a brand, entertainment, etc.) having a first component, second neuro-response data obtained from the subject after exposure to the first stimulus and prior to exposure to a second stimulus, third neuro-response data obtained from the subject after exposure to the second stimulus, and fourth neuro-response data obtained from the subject after exposure to a third stimulus having the first component. Some example methods also include determining, using a hardware (e.g., semi-conductor based) processor, a change in a subject resonance to the first component based on a comparison of a first difference between the first neuro-response data and the second neuro-response data relative to a second difference between the third neuro-response data and the fourth neuro-response data.

In some example method(s), the first stimulus and the third stimulus are identical.

In some example method(s), the first difference is a first differential event related potential measurement and the second difference is a second differential event related potential measurement. Some example method(s) include determining at least one of a subject resonance to the first stimulus based on the first differential event related potential measurement or a subject resonance to the second stimulus based on the second differential event related potential measurement. In some example method(s), the change in the subject resonance to the first component is based on a comparison of the first differential event related potential relative to the second differential event related potential. Some example method(s) also include calculating a third difference t based on the second neuro-response data and the third neuro-response data and determining a subject resonance to the second stimulus based on the third difference. Some example method(s) include determining an effect of the second stimulus material with respect to the first component based on the change.

In some example method(s), the first component is a master brand and the second stimulus includes a sub-brand, the master brand and the sub-brand owned by a same entity.

In some example method(s), the first component is a first brand for a first entity and the second stimulus includes a second brand for a second entity.

Some example systems disclosed herein include an analyzer to analyze first neuro-response data obtained from a subject prior to exposure to a first stimulus having a first component, second neuro-response data obtained from the subject after exposure to the first stimulus and prior to exposure to a second stimulus, third neuro-response data obtained from the subject after exposure to the second stimulus, and fourth neuro-response data obtained from the subject after exposure to a third stimulus having the first component. In some such example systems, the system includes a calculator to calculate a first difference between the first neuro-response data and the second neuro-response data and a second difference between the third neuro-response data and the fourth neuro-response data. Also, in some such systems, the comparer is to compare the first difference and the second difference to determine a change in a subject resonance to the first component.

In some example system(s), the first stimulus and the third stimulus are identical.

In some example system(s), the first difference is a first differential event related potential measurement. Some such system(s) include a resonance estimator to determine a subject resonance to the first stimulus based on the first differential event related potential measurement. In some such system(s), the second difference is a second differential event related potential measurement and the resonance estimator is to determine a subject resonance to the third stimulus based on the second differential event related potential measurement. In some such system(s), the comparer is to compare the first differential event related potential and the third differential event related potential and the resonance estimator is to determine the change in the subject resonance to the first component based on the comparison of the first differential event related potential relative to the third event related potential. Also, in some example system(s), the processor is to calculate a third difference based on the second neuro-response data and the third neuro-response data and the resonance estimator is to determine a subject resonance to the second stimulus based on the third difference.

In some example systems(s), the resonance estimator is to determine an effect of the second stimulus material with respect to the first component based on the change.

In some example system(s), the first component is a master brand and the second stimulus includes a sub-brand, the master brand and the sub-brand owned by a same entity. In some examples, the master brand and the sub-brand are owned by different entities (e.g., competitors).

Example machine readable storage medium disclosed herein comprise instructions, which, when read, cause a machine to at least access first neuro-response data obtained from a subject prior to exposure to a first stimulus having a first component, second neuro-response data obtained from the subject after exposure to the first stimulus and prior to exposure to a second stimulus, third neuro-response data obtained from the subject after exposure to the second stimulus, and fourth neuro-response data obtained from the subject after exposure to a third stimulus having the first component. Also, the instructions of some of the examples cause the machine to determine a change in a subject resonance to the first component based on a comparison of a first difference between the first neuro-response data and the second neuro-response data relative to a second difference between the third neuro-response data and the fourth neuro-response data.

In some examples, the first difference is a first differential event related potential measurement and the second difference is a second differential event related potential measurement and the instructions cause the machine to determine a subject resonance to the first stimulus based on the first differential event related potential measurement and determine a subject resonance to the third stimulus based on the second differential event related potential measurement. Also, in some such examples, the instructions cause a machine to compare the first differential event related potential and the third differential event related potential and determine a change in the subject resonance to the first component is based on the comparison of the first differential event related potential relative to the third differential event related potential.

In some examples, the instructions further cause the machine to calculate a third difference between the second neuro-response data and the third neuro-response data and determine a subject resonance to the second stimulus based on the third difference.

In some examples, the first stimulus and the third stimulus are identical.

In some examples, the instructions further cause the machine to determine an effect of the second stimulus material with respect to the first component based on the change.

In some examples, the first component is a master brand and the second stimulus includes a sub-brand, the master brand and the sub-brand owned by a same entity.

In some examples, the first component is a first brand for a first entity and the second stimulus includes a second brand for a second entity.

Some example methods disclosed herein include accessing first neuro-response data obtained from a subject prior to exposure to a first brand, second neuro-response data obtained from the subject after exposure to the first brand and prior to exposure to a second brand, third neuro-response data obtained from the subject after exposure to the second brand, and fourth neuro-response data obtained from the subject after exposure to the first brand and after exposure to the second brand, wherein the second brand shares an attribute with the first brand. Some methods also include determining, using a processor, a change in a subject resonance to the first brand based on a comparison of a first difference between the first neuro-response data and the second neuro-response data relative to a second difference between the third neuro-response data and the fourth neuro-response data.

In some example method(s), the attribute is at least one of ownership, a product offering, a service offering, a packaging, a price, or an advertisement.

In some example method(s), the first brand is owned by a first entity and the second brand is owned by a second entity.

In some example method(s), the first brand is a master brand and the second brand includes a sub-brand. In some such methods, the master brand and the sub-brand owned by a same entity.

In some example method(s), the first brand is a master brand and the second brand is a sub-brand presented in an advertisement. In some such methods, the master brand and the sub-brand owned by a same entity.

Some example methods include determining an effect of the second brand with respect to the first brand based on the change. In some such methods, the change is indicative of a difference in a first association between the first brand and a characteristic and a second association between the first brand and the characteristic.

In some example method(s), the first difference is a first differential event related potential measurement and the second difference is a second differential event related potential measurement.

In some example method(s), the change to the subject resonance is based on a comparison of the first differential event related potential relative to the second differential event related potential.

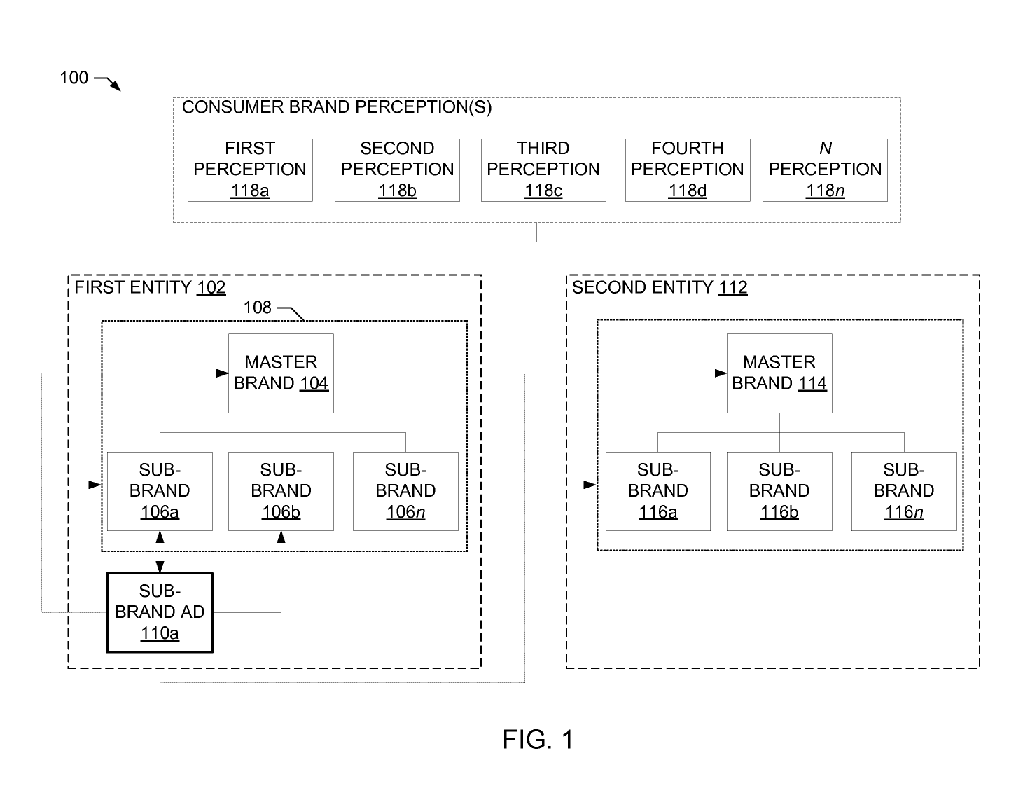

Turning now to the figures, FIG. 1 is a schematic illustration of example cross-brand and/or competitor brand relationships. In this example, a first entity 102 (e.g., a company) may own one or more brands, including, for example, a master brand 104. The master brand 104 may be associated with one or more sub-brands 106a-n. For example, The Coca-Cola company owns Coca-Cola® (e.g., a master brand), which is associated with various sub-brands, including Diet Coke®, Coca-Cola Zero®, and Cherry Coke®. As described above, the master brand 104 and the sub-brands 106a-n have one or more attributes, and in some examples, one or more shared attributes. For example, a product and/or service associated with the example sub-brand 106a may be partially related to a product and/or service associated with the master brand 104 (e.g., types of soft drinks). In other examples, the relationship between the master brand 104 and the example sub-brands 106a is based on overlapping ownership and may not be based on related product and/or service attributes and/or characteristics. For example, PepsiCo owns the Pepsi® brand for soft drinks and the Quaker® brand for breakfast cereals. Other relationships and/or combinations of relationships between the master brand 104 and the sub-brands 106a-n are possible. Also, in some examples, the master brand 104 and the sub-brands 106a-n form a portfolio such as the example portfolio 108 of brands shown in FIG. 1, which is owned by the first entity 102. A portfolio may include one or more master brands and/or a combination of master brands and/or sub-brands. For example, The Coca-Cola Company owns a variety of brands and sub-brands in addition to those associated with CocaCola®, including, for example Dasani® (bottled water), Powerade® (sports drinks), and Odwalla® (juices).

In the illustrated example, an advertisement 110a is associated with the sub-brand 106a. In some examples, the advertisement 110a is part of a marketing campaign directed toward the sub-brand 106a and/or one or more attributes of the sub-brand 106a. In some examples the advertisement 110a is any type of stimulus related to the brand including, for example, a logo, a trademark, an audio commercial, a video commercial, product packaging and/or a product specimen.

In the illustrated example, a second entity 112 (e.g., a company) owns a respective master brand 114 and respective sub-brands 116a-n. In some examples, the second entity is a marketplace competitor to the first entity 102. For example, one or more of the brands owned by the first entity 102 (e.g., the master brand 104 and/or the sub-brands 106a-n) and one or more of the brands owned by the second entity 104 (e.g., the master brand 114 and/or the sub-brands 116a-n) may be associated with a similar product, service, and/or other attribute. For example, PepsiCo owns a variety of drink brands in competition with The Cola-Cola Company, such as Pepsi® and Diet Pepsi® (soft drinks), Aquafina (bottled water), and Gatorade® (sports drinks).

As shown in the illustrated example, a consumer may have one or more consumer brand perceptions 118a-n (e.g., attention, emotional engagement, memory, resonance, awareness, favorable/unfavorable impression, etc.) of one or more of the brands owned by the first entity 102 and/or one or more of the brands owned by the second entity 112. In some examples, the consumer may have one or more perceptions 118a-n of one of the brands (e.g., the master brand 104) but no perception (e.g., no awareness) of another of the brands owned by the first entity 102 (e.g., the sub-brand 106a) and/or the second entity 112 (e.g., the sub-brand 116a). In other examples, the consumer may have a first perception 118a for the master brand 104 (e.g., a brand associated with “fun”) and a second perception 118b for the sub-brand 106a (e.g., a brand associated with “healthy”). The consumer brand perceptions 118a-n may be positive (e.g., the consumer views one or more of the brands in the brand portfolio 108 as associated with the concept of “healthy”) or negative (e.g., the consumer views one or more of the brands in the brand portfolio 108 as associated with the concept of “unhealthy”). One or more of the consumer brand perceptions 118a-n may be directed toward one or more of the brands owned by the first entity 102 and/or one or more of the brands owned by the second entity 112.

In the illustrated example, the first entity 102 initiates a marketing campaign directed toward the sub-brand 106a via the sub-brand advertisement 110a. For example, the Coca-Cola Company may implement a marketing campaign directed toward Coca-Cola Zero® as a health-conscious, or healthy, choice with respect to soft drinks. As part of the marketing campaign, the consumer may be exposed to the sub-brand advertisement 110a. The sub-brand advertisement 110a is intended to impact the sub-brand 106a (e.g., affect the consumer's perception of the sub-brand 106a). For example, the consumer may view an advertisement for Coca-Cola Zero® (e.g., the advertisement 110a for the sub-brand 106a) indicating that the soft drink has zero calories and may form an association, or a first perception 118a, between the concept of “healthy” and Coca-Cola Zero®. Additionally or alternatively, as illustrated in FIG. 1, the sub-brand 106a and/or the sub-brand advertisement 110a may have an (intended or unintended) impact on, for example, one or more of the master brand 104, another sub-brand 106b, 106n, the example portfolio 108 owned by the first entity, the first entity 102 itself, and/or the master brand 114 and/or the sub-brands 116a-n owned by the second entity 112.

For example, after viewing the advertisement 110a for the sub-brand Coca-Cola Zero®, the consumer may more strongly associate the concept of “healthy” with the master brand Coca-Cola® as compared to the consumer's perceptions 118a-n of Coca-Cola® prior to exposure to the advertisement 110a for Coca-Cola Zero®. For example, prior to exposure to the advertisement 110a, the consumer may have a second perception 118b of Coca-Cola® as being associated with drink options that are unhealthy. After being exposed to the advertisement 110a for Coca-Cola Zero®, the consumer may have a third perception 118c of Coca-Cola® as being associated with healthy soft drink options. In such examples, the advertisement 110a for the sub-brand 106a (e.g., Coca-Cola Zero®) impacted the consumer's perceptions 118a-n with respect to the sub-brand 106a and the master brand 104. In further examples, the advertisement 110a can impact the consumer's perceptions 118a-n of the first entity 102 (e.g., The Coca-Cola Company offers healthy drink options).

In other examples, the advertisement 110a directed toward Coca-Cola Zero® may impact the consumer's perception of competing brands owned by PepsiCo (e.g., the second entity 112). For example, after viewing the advertisement 110a for Coca-Cola Zero® as having zero calories, the consumer's fourth perception 118d with respect to an association between the concept of “healthy” and PepsiCo may be impacted (e.g., the consumer may be less likely to associate the concept of “healthy” with PepsiCo in view of The Coca-Cola Company owning a soft drink brand that has zero calories). There may also be examples in which a healthy option offered by PepsiCo negatively impacts a consumer's perception of brands owned by The Coca-Cola Company. In other examples, an advertisement campaign directed toward a sub-brand 106a that a consumer may not be aware is owned by an entity 102 (e.g., Odwalla® juices owned by The Coca-Cola Company) may have an impact on the consumer's perceptions 118a-n of the entity 102 as well as the entity's other master and/or sub-brands 104, 106a-n when the consumer becomes aware of the association. For example, an advertisement 110a for Odwalla® juices may result in the consumer's perceptions 118a-n including an association of The Coca-Cola Company with the concept of “healthy” upon the consumer learning that the Odwalla® juice brand is owned by The Cola-Cola Company. Any of these effects may be positive or negative. An advertisement and/or marketing campaign for a master brand and/or a sub-brand, thus, results in a cross-brand market impact on a consumer's perception of other master and/or sub-brands owned by that same entity (e.g., there may be impacts upon the sub-brand associated with the advertisement, other sub-brands, master brands, and/or brand portfolios owned by the same entity or by other entities). In addition, the cross-brand market impact of the sub-brand may extend to a consumer's perception of brands owned by, for example, a competing entity.

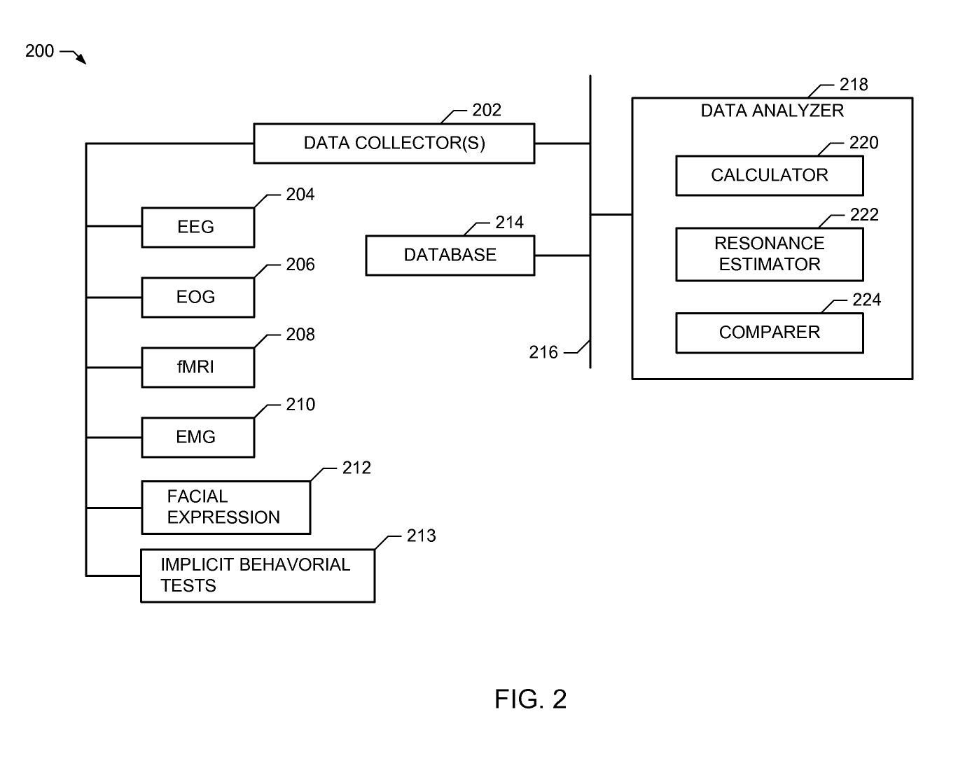

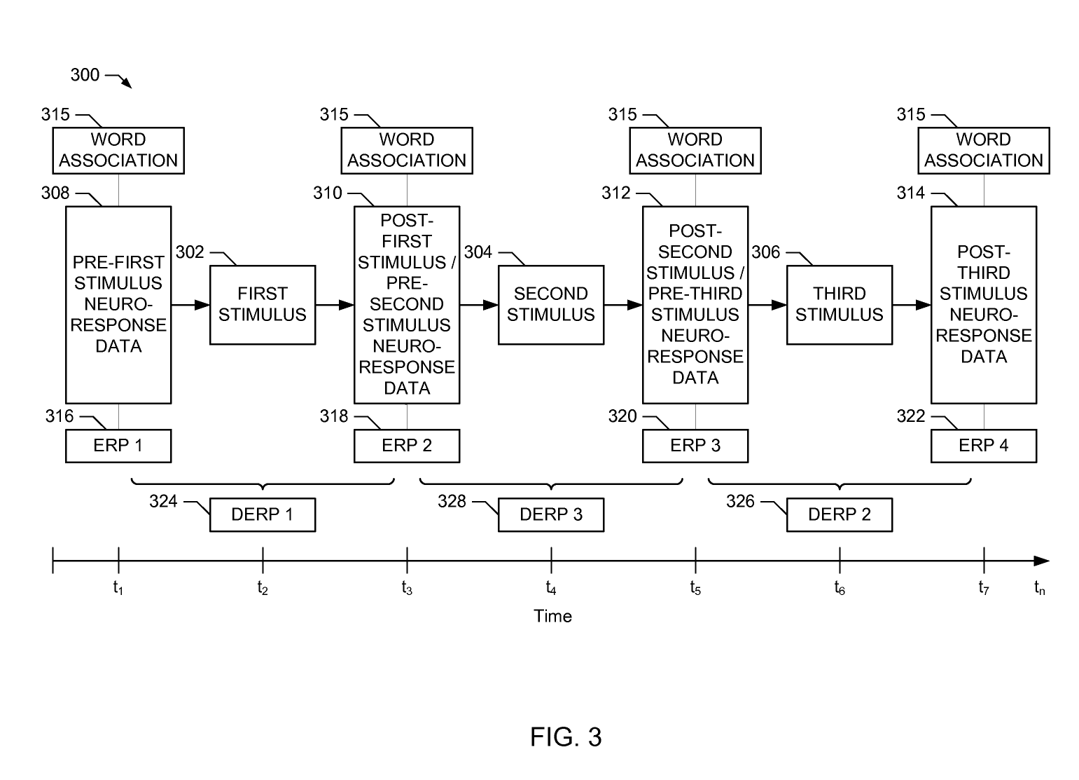

FIG. 2 is an example system 200 constructed in accordance with the teachings of this disclosure to measure cross-brand market impact using neurological data. The example system 200 of FIG. 2 includes one or more data collector(s) 202 to obtain neuro-response data from a subject before and after the subject is exposed to one or more stimuli. For example, as shown in the timeline of the example process 300 of FIG. 3, a subject may be presented with a first stimulus 302, a second stimulus 304, and a third stimulus 306. In some examples, the first, second, and third stimuli 302, 304, 306 are presented in successive time order at times t₂, t₄ and t₆, respectively, as illustrated in FIG. 3. In other examples, the first, second, and third stimuli 302, 304, 306 are presented in a different time order. In addition, the time represented in FIG. 3 may be minutes, days, months and/or any other suitable time scale, and the time segments do not necessarily represent even divisions of time. For example the difference in time between t₁ and t₂ is not necessarily the same as the amount of time between t₂ and t₃.

The first, second, and third stimuli 302, 304, 306 may include, for example, a sub-brand, an advertisement for a sub-brand, a master brand associated with the sub-brand, a master or sub-brand sharing one or more attributes of the master brand and/or the sub-brand, and/or a master brand(s) and/or sub-brand(s) in a portfolio of brands owned by the same entity or different entities, such as a competitor. In instances where the first, second, and third stimuli 302, 304, 306 are a master or sub-brand rather than, for example, an advertisement, the stimuli may include a logo and/or other form of media communicating the master or sub-brand to the subject. In the example process 300, the first stimulus 302 and the third stimulus 306 may be a master brand and the second stimulus 304 may be a sub-brand or an advertisement for a sub-brand of the master brand.

The data collector(s) 202 of FIG. 2 collect neuro-response data prior to exposure to, for example, the first stimulus 302 of FIG. 3. For example, as shown in FIG. 3, neuro-response data 308 is collected at time t₁. In the example process 300 of FIG. 3, the first stimulus 302 is presented at time t₂ (e.g., after the data collector 202 collects the neuro-response data at time t₁) Also in the example process 300, post-first stimulus neuro-response data 310 is collected after exposure to the first stimulus 302 (e.g., at time t₃). Similarly, in the example process 300, the second stimulus 304 is presented at time t₄. In such examples, the post-first stimulus neuro-response data 308 also serves as the pre-second stimulus neuro-response data. Also, post-second stimulus neuro-response data 312 is collected at time t₅. In the example process 300, the third stimulus is presented at time t₆ and post-third stimulus neuro-response data is collected at time t₇. In such examples, the post-second stimulus neuro-response data 310 also serves as the pre-second stimulus neuro-response data.

In some examples, the neuro-response data 308, 310, 312, 314 is collected at times t₁, t₂, t₃, and t₄ during the presentation of a word 315 to the subject for which an association of the word 315 with one or more of the first, second, and/or third stimuli 302, 304, 306 is of interest. The word 315 may be representative of a concept or idea that one or more of the master brand, sub-brand, and/or advertisements for the brands may intentionally and/or unintentionally portray (or not portray) to the subject, such as “healthy”, “fun”, “luxury”, etc. For example, a subject's association between the word “healthy” and a master brand such as Coca-Cola® may be of interest in view of sub-brands or sub-brand advertising associated with Coca-Cola® (e.g., Coca-Cola Zero®) to evaluate how consumers view Coca-Cola® with respect to health-conscious purchasing decisions. In such examples, at times t₁, t₃, t₅, and t₇, the word “healthy” (e.g., the word 315) is presented to the subject (e.g., on a screen) at multiple times (e.g., before and after exposure to the master brand (e.g., the first stimulus 302) at time t₂, before and after exposure to the sub-brand (e.g., the second stimulus 304) at time t₄, and before and after re-exposure to the master brand (e.g., the third stimulus 306) at time t₆). Also at times t₁, t₃, t₅, and t₇, the data collector(s) 202 collect the neuro-response data 308, 310, 312, and 314 during the presentation of the word 315 to the subject. In some examples, the word 315 is presented one or more times in sequence with the first, second, and third stimuli 302, 304, 306. For example, the word 315 may be presented one or more times at time t₁ and t₃ (i.e., before and after presentation of the first stimulus 302). In other examples, the word 315 includes one or more words presented at one or more of times (e.g., times t₁, t₃, t₅, and t₇).

In other examples, the concepts or ideas conveyed by the word 315 are communicated through other instruments. For example, images of athletes or people exercising may convey the concept of healthy. In some examples, the sounds of a nightclub or party may convey the concept of fun. Any suitable communications platform to convey a concept or idea of interest may be used.

The example data collector(s) 202 of FIG. 2 collect the neurological data and/or physiological measurements via the example process 300 of FIG. 3, which may be used to evaluate a subject's perception(s) of one or more of a sub-brand, an advertisement for a sub-brand, and/or a master brand (e.g., the first, second, and/or third stimuli 302, 304, 306 of FIG. 3). The example data collector(s) 202 may include, for example, one or more electrode(s), camera(s) and/or other sensor(s) to gather any type(s) of neurological and/or physiological data, including, for example, facial expressions, heart rate, galvanic skin response, electrooculographic (EOG) data, pupillary dilation, functional magnetic resonance (fMRI) data (which measures blood oxygenation in the brain that correlates with increased neural activity by detecting changes in blood flow), electroencephalography (EEG) data (which measures brainwave signals in time and frequency bands including delta, theta, alpha, beta, and gamma frequency ranges that can be used, for example, to calculate ERP data as disclosed herein), magnetoencephalography (MEG) data (which measures magnetic fields produced by electrical activity in the brain using a magnetometer to map brain activity by mapping the recorded magnetic fields), optical imaging data (which employs lasers positioned on the scalp to emit a light path, may be used to measure the absorption or scattering of the light related to concentration of chemicals in the brain or neurons associated with neuronal firing), and/or other neurological and/or physiological data. The data collector(s) 202 of the illustrated example may gather data continuously, periodically and/or aperiodically.

In the illustrated example, the data collector(s) 202 collect neurological, physiological, and/or behavioral data from multiple sources and/or modalities. In the illustrated example, the data collector(s) 202 include components to gather EEG data 204 (e.g., scalp level electrodes), components to gather EOG data 206 (e.g., shielded electrodes), components to gather fMRI data 208 (e.g., a differential measurement system), components to gather EMG data 210 to measure facial muscular movement (e.g., shielded electrodes placed at specific locations on the face) and/or components to gather facial expression data 212 (e.g., a video analyzer). In some examples, the data collector(s) include components to gather subject behavioral data collected during implicit behavioral tests 213, such as the subject's response time between viewing a brand logo on a computer screen and clicking a word from two or more words presented on the screen contemporaneously and with which the subject associates the brand. The data collector(s) 202 may also include one or more additional sensor(s) to gather data related to any other modality of data collection including, for example, GSR data, MEG data, EKG data, pupillary dilation data, eye tracking data, facial emotion encoding data and/or reaction time data. Other example sensors include cameras, microphones, motion detectors, gyroscopes, temperature sensors, response latency detectors, etc., which may be integrated with and/or coupled to the data collector(s) 202.

In some examples, only a single data collector 202 is used. In other examples a plurality of data collectors 202 are used. Data collection is performed automatically in the example of FIG. 2. In addition, in some examples, the data collected is digitally sampled and stored for later analysis such as, for example, in a database 214. In some examples, the data collected is analyzed in real-time or near real-time. In the example system 200 of FIG. 2, the data collector(s) 202 are communicatively coupled to other components of the example system 200 via communication links 216. The communication links 216 may be any type of wired (e.g., a databus, a USB connection, etc.) or wireless communication mechanism (e.g., radio frequency, infrared, etc.) using any past, present or future communication protocol (e.g., Bluetooth, USB 2.0, etc.). Also, the components of the example system 200 may be integrated in one device or distributed over two or more devices.

The illustrated example system 200 of FIG. 2 includes a data analyzer 218. The example analyzer 218 of FIG. 2 receives the data gathered from the data collector(s) 202 and analyzes the data for trends, patterns and/or relationships. The analyzer 218 of the illustrated example reviews data collected via a particular modality (e.g., EEG data) and between two or more different data collection modalities (e.g., EEG data and eye tracking data). Thus, the analyzer 218 of the illustrated example provides an assessment of intra-modality measurements (e.g., data collected within a single data collection type) and cross-modality measurements (e.g., data collected using two or more different data collection types). In some examples, the analyzer 218 provides an assessment of the pre- and post-stimuli neuro-response data 308, 310, 312, and 314 obtained via the example process 300 of FIG. 3.

With respect to intra-modality measurements, in some examples, brain activity is measured via the EEG data to determine regions of activity and to determine interactions and/or types of interactions between various brain regions and/or various frequencies of brain activity. Measuring signals in different regions and/or frequencies of the brain and timing patterns between such regions and/or frequencies provides data from which attention, emotion, memory and/or other neurological states can be recognized. For example, the data analyzer 218 may provide an assessment of EEG data collected via the data collector(s) 202 at times t₁ and t₃ based on brainwave frequencies in the theta range and the gamma range, both of which are associated with memory and may be active during presentation of the word 315 and/or the first stimuli 302 (e.g., the master brand). Theta and gamma band frequency data may be collected again at times t₅ and t₇ after exposure of the subject to the second stimulus 304 (e.g., the sub-brand). In this example, the theta and gamma band frequency data may be used to assess a change in the subject's association of the word 315 with third stimulus 306 (e.g., the master brand) relative to the brainwave data analyzed at times t₁ and t₃ before and after presentation of the first stimulus 302 (e.g., the master brand) and before presentation of the second stimulus 304. Such data may be used to draw reliable conclusions about a subject's perceptions (e.g., associations brand concepts, engagement level, alertness level, etc.) and, thus, to provide the basis for determining the effectiveness of and/or resonance to the sub-brand advertisement with respect to the sub-brand and/or, for example, another sub-brand, a master brand, and/or a competitor brand.

For example, the neuro-response data may show that data in a first frequency band is in phase or out of a phase with data in a second frequency band. Such in phase or out of phase waves in two different frequency bands are indicative of a particular communication, action, emotion, thought, fluency of processing etc. For example, if a subject's EEG data shows high theta band activity occurring simultaneously with high gamma band activity, both of which are indicative of effective communication, an estimation may be made that the subject's perceptions of contemporaneously presented sub-brand marketing is one of alertness, attentiveness and high propensity of retention. If a subject's EEG data also shows relatively higher theta band and high gamma band activity during presentation of the word 315 at times t₅ and t₇ (e.g., after exposure to the sub-brand and before/after re-exposure to the master brand) as compared to the EEG data collected prior to exposure to the sub-brand at times t₁ and t₃, an estimation may be that the subject's perceptions of the master brand with respect to association with the word 315 have been affected (e.g., increased) by the presentation of the sub-brand marketing.

Also, in some examples, brain activity in one frequency band is active while brain activity in another, different, frequency band is inactive. Such circumstances enable the data collector 202 to detect the active band because the inactive band is not obscuring or drowning out the active band. A circumstance in which one band is active and a second, different band is inactive is indicative of a particular communication, action, emotion, thought, etc. For example, neuro-response data showing increasing theta band activity occurring simultaneously with decreasing alpha band activity provides a measure that internal focus is increasing (theta) while relaxation is decreasing (alpha), which together suggest that the subject is actively processing the stimulus (e.g., the sub-brand advertisement). The neuro-response data collected after re-exposing the subject to the master brand after exposure to the sub-brand may reflect the subject's processing of the master brand in view of the sub-brand stimulus. For example, increased theta band activity detected during presentation of the master brand after exposure to the sub-brand may reflect that the subject is actively processing the stimulus (i.e., the master brand) in connection with memory and engagement levels at least partially influenced by prior exposure the sub-brand advertisement.

In some examples, actual expressed responses (e.g., survey data) and/or actions for one or more subject(s) or group(s) of subjects may be integrated with neurological and/or physiological data and stored in the database or repository 214 in connection with one or more advertisement(s) and/or brand(s). In some examples, the actual expressed responses may include, for example, a subject's stated perception and/or demographic and/or preference information such as an age, a gender, an income level, a location, interests, buying preferences, hobbies and/or any other relevant information. The actual expressed responses may be combined with the neurological and/or physiological data to verify the accuracy of the neurological and/or physiological data, to adjust the neurological and/or physiological data, to determine the effectiveness of the sub-brand marketing, and/or to determine the impact of the sub-brand or the sub-brand marketing on the sub-brand, another sub-brand, the master brand, and/or a competitor brand. For example, a subject may provide a survey response that details the subject's perception of the sub-brand and/or the master brand based on the sub-brand advertisement. The survey response can be used to validate neurological and/or physiological response data that indicated that the subject was engaged and memory retention activity was high. The survey response can also be used to clarify the reasons behind observed neurological and/or physiological response data that indicated that the subject was disengaged or distracted while viewing one or more of the stimuli.

In the illustrated example, the data analyzer 218 derives, using, for example, a calculator 220, event related potential (ERP) measurements from the neuro-response data (e.g., the EEG data 204). In some examples, ERP measurements are calculated for different regions of the brain both before and after the subject is exposed to the one or more stimuli to measure brain responses to the one or more stimuli. In some such examples, ERP measurements are derived from the neuro-response data 308, 310, 312, 314 collected during presentation of the word 315. In some examples, the calculator 220 calculates target ERP measurements associated with exposure of the subject to the one or more stimuli (e.g., a stimulus of interest) and distractor ERP measurements associated with exposure of the subject to material other than the one or more stimuli (e.g., a stimulus other than the stimulus of interest used, for example, for comparison purposes).

For example, referring to the example process 300 of FIG. 3, the calculator 220 derives a first ERP measurement 316 from the pre-first stimulus neuro-response data 308 collected at time t₁. Also, the calculator derives a second ERP measurement 318 from the post-first stimulus neuro-response data collected at time t₃ (e.g., after exposure to the first stimulus at time t₂). Similarly, the calculator 220 derives a third ERP measurement 320 from the post-second stimulus neuro-response data 312 and a fourth ERP measurement 322 derived from the post-third stimulus neuro-response data 314. In some examples, the first, second, third, and fourth ERP measurements 316, 318, 320, 322 occur in real-time or near real-time. For example, the first ERP measurement 316 is calculated at t₁, the second ERP measurement 318 is calculated at t₃, the third ERP measurement 320 is calculated at t₅, and the fourth ERP measurement 322 is calculated at t₇. In other examples, one or more of the first, second, third, and/or fourth ERP measurements 316, 318, 320, 322 are calculated at any other time provided that the data used in the respective calculation has been gathered. In some examples, one or more of the ERP measurements 316, 318, 320, 322 are calculated at a later time, tₙ.

As disclosed above, in some examples the first, second, and/or third stimuli 302, 304, 306 represent a master brand/sub-brand relationship, such that the first and third stimuli 302, 306 represent the master brand and the second stimulus 304 is the sub-brand. In such examples, the calculator 220 of the illustrated example analyzes the neuro-response data 308, 310 collected at times t₁ and t₃, with the subject exposed to the master brand (e.g., the first stimulus 302) at time t₂. The calculator 220 calculates the first ERP 316 and the second ERP 318 based on the respective pre- and post-first stimulus neuro-response data 308, 310. In response to exposure of the subject to the sub-brand (e.g., the second stimulus 304) at time t₄, the calculator 220 calculates the third ERP 320 based on the post-second stimulus neuro-response data 312. Also, the calculator 220 calculates the fourth ERP 322 at time t₇ in response to re-exposure of the subject to the master brand (e.g., the third stimulus 306).

In the illustrated example, the word 315 is presented to the subject during collection of the neuro-response data 308, 310, 312, 316 at each of times t₁, t₃, t₅, and t₇. Thus, the first, second, third, and fourth ERP 316, 318, 320, 322 reflect the subject's response to the word 315 presented at the different times t₁, t₃, t₅, and t₇, respectively. Because the times t₁, t₃, t₅, and t₇ are associated with pre- and post-exposure to the first, second, and third stimuli 302, 304, 306, the first, second, third, and fourth ERP 316, 318, 320, 322 reflect the subject's association of the word 315 as impacted by exposure to the first, second, and third stimuli 302, 304, 306, respectively. For example, the second ERP 318 may reflect the subject's response to the presentation of the word 315 at time t₂ after to exposure to the first stimulus (e.g., the master brand).

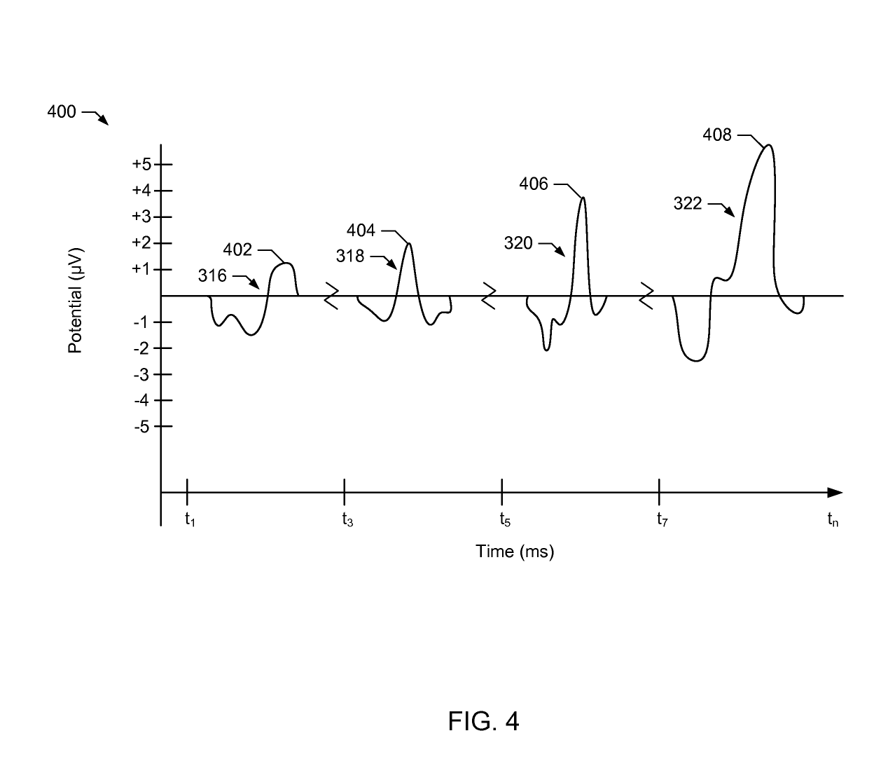

FIG. 4 illustrates example first, second, third, and fourth ERPs 316, 318, 320, 322 of FIG. 3 as waveforms that are derived by the calculator 220 from the neuro-response data 308, 310, 312, 314 collected during presentation of the word 315 at times t₁, t₃, t₅, and t₇. In FIG. 4, the ERPs 316, 318, 320, 322 are plotted as waveforms including positive and negative voltage deflections against latency (e.g., a delay between presentation of a stimulus and a response, such as, for example, a time interval between the presentation of the word 315 at times t₁, t₃, t₅, and t₇ and an onset of the subject's neurological response). As disclosed above, ERPs 316, 318, 320, 322 are derived at each time t₁, t₃, t₅, and t₇, thus resulting in four ERP waveforms, as shown in FIG. 4. In some examples, ERP measurements are derived at each time tₙ, thereby resulting in additional waveforms plotted on the graph of FIG. 4.

The subject's response to the word 315 in the first, second, third, and fourth ERPs 316, 318, 320, 322 may be determined by detecting components in the ERP data based on, for example, one or more of average amplitude, peak amplitude, latency, or area under the curve (e.g., integration). For example, a P300 wave is an ERP component that is associated with decision making and implicit perception, and appears as a positive voltage deflection with a latency of approximately 250 to 500 milliseconds (ms) and peaking around 300 ms after exposure to the stimulus. A N400 ERP component is a negative voltage deflection peaking around 400 ms after exposure to the stimulus and is associated with brain responses to words.

FIG. 4 shows ERP waveform components 402, 404, 406, 408 respectively associated with the ERPs 316, 318, 320, 322. For example, the first ERP 316 includes a first ERP component 402 (e.g., a P300 component peaking around 500 ms after the exposure to the word 315 having a peak amplitude of +1.24 μV). The example second ERP 318 includes a second ERP component 404 having a peak amplitude of +2.33 μV. The example third ERP 320 includes a third ERP component 406 having a peak amplitude of +3.51 μV. Also, in FIG. 4, the example fourth ERP 322 includes a fourth ERP component having a peak amplitude of +4.97 μV. Although specific examples are shown in FIG. 4, the first, second, third, and fourth ERP components 402, 404, 406, 408 may alternatively be associated with different ERP components (e.g., ERP components having positive or negative voltage deflections (e.g., P250, P300, N400, P500, etc.)). Additionally, each of the ERP waveforms illustrated in FIG. 4 may include one or more ERP components.

To determine an association of the subject with the word 315 and a respective stimulus 302, 304, 306, the example calculator 220 calculates differential measurements of the pre- and post-stimulus and/or target and distractor stimulus ERP measurements to obtain differential event related potential (DERP) measurements across multiple regions of the brain. In some examples, as will be further discussed below, the DERP measurements provide an assessment of the subject resonance to the stimulus, including, for example, a sub-brand, an advertisement for sub-brand, and/or a master brand.

For example, with respect to the ERP measurements obtained via the example process 300 of FIG. 3, the calculator 220 calculates a first DERP measurement 324 based on the first ERP measurement 316 and the second ERP measurement 318 (e.g., the first DERP measurement 324 may reflect amplitude differences between the first ERP measurement 316 and the second ERP measurement 318). Thus, the first DERP measurement 324 is associated with the neuro-response data 308, 310 collected before and after exposure to the first stimulus and the presentation of the word 315 presented at times t₁ and t₃. Also as described above, in the example process 300, neuro-response data 312, 314 is collected before and after exposure to the third stimulus 306, which, in some examples, is the same stimulus as the first stimulus 302. The calculator 220 calculates a second DERP 326 based on the third ERP measurement 320 and the fourth ERP measurement 322. Thus, the second DERP measurement 326 is associated with the neuro-response data 312, 314 collected before and after exposure to the third stimulus 306 and the presentation of the word 315 at times t₅ and t₇.

As an example and referring to FIG. 4, the calculator 220 may calculate the first DERP measurement 324 based on amplitude differences between the first ERP component 402 of the first ERP 316 and the second ERP component 404 of the second ERP 318. Using the example amplitudes described above (e.g., the first ERP component 402 having a peak amplitude of +1.01 μV and the second ERP component 404 having a peak amplitude of +2.04 μV), the first DERP measurement 324 has a value of +1.03 μV. Similarly and in continued reference to FIG. 4, the second DERP measurement 326 has a value of +1.42 μV (e.g., the amplitude difference between the third ERP component 406 having a peak amplitude of +3.55 μV and the fourth ERP component 408 having a peak amplitude of +4.97 μV).

Also, the post-first stimulus neuro-response data 310 serves as the pre-second stimulus neuro-response data (e.g., prior to exposure to the second stimulus 304). Also, the pre-third stimulus neuro-response data 312 serves as the post-second stimulus neuro-response data (e.g., after exposure to the second stimulus 304). As such, in some examples, the calculator 220 calculates a third DERP measurement 328 based on the second ERP measurement 318 and the third ERP measurement 320. Thus, the third DERP measurement 328 is associated with the neuro-response data 310, 312 collected before and after exposure to the second stimulus 304 and the presentation of the word 315 at times t₃ and t₅. For example, referring to FIG. 4, the calculator 220 calculates the third DERP measurement 328 based on the amplitude difference between the second ERP component 404 and the third ERP component 406. Using the example values assigned to the second ERP component 404 (e.g., +2.04 μV) and the third ERP components 406 (e.g., +3.55 μV), the third DERP measurement 328 has a value of +1.51 μV.

The first, second, and third DERP measurements 324, 326, 328 reflect the subject's attention, memory, and/or engagement levels. In some examples, the first, second, and third DERP measurements 324, 326, 328 occur in real-time or near real-time. For example, the first DERP measurement 324 is calculated between t₁ and t₃, the second DERP measurement 326 is calculated between t₅ and t₇, and the third DERP measurement 328 is calculated between t₃ and t₅. In other examples, one or more of the first, second, and third DERP measurements 324, 326, 328 are calculated at any other time provided that the data used in the respective calculation has been gathered. In some examples, one or more of the DERP measurements 324, 326, 328 are calculated at a later time, (e.g., tₙ). Also, other analytical methods for calculating DERP measurements may be used by the calculator 220 alternatively or in addition to determining peak amplitude differences of the ERP components. For example, the first, second, and third DERP measurements 324, 326, 328 may be determined based on differentials between areas under the curves (e.g., DERP_{c}=∫ERP_{A}−∫ERP_{B}), average amplitudes, etc.

In some examples, single trials and/or averages of DERP measurements are used to enhance the assessment of subject resonance. In other examples, DERP measurements are calculated for a plurality of subjects to obtain subject resonance for an audience based on geographic attributes, demographic attributes, etc. In other examples, DERP measurements across subjects could be made using a normalized or scaled signal rather than the raw measurement. Such scaling can be achieved using subject physiology dependent scaling factors and/or a database driven scaling factor. The measurements derived using the calculator 220 may be stored in the database 214. To this end, the calculator 220 is communicatively coupled to the database 214.

As disclosed above, in some examples, the DERP measurements provide an assessment of the subject resonance to a stimulus (e.g., the first, second, and/or third stimuli 302, 304, 306 of FIG. 3). In particular, the DERP measurements 324, 326, 328 indicate the subject's association of the word 315 with the first, second, and third stimuli 302, 304, 306. To determine the subject resonance based on the DERP measurements, the example system 200 of FIG. 2 includes a resonance estimator 222. The resonance estimator 222 of the illustrated example analyzes one or more of the DERP measurements and determines a level of subject resonance to the one or more stimuli, including, for example, the sub-brand, the sub-brand advertisement, the master brand, a competing master brand and/or a competing sub-brand, one or more other master brands and/or sub-brands, and/or one or more attributes associated with the sub-brand, the master brand, the competing brands and/or the one or more other master brands and/or sub-brands. The attributes may include attributes of product(s) or service(s) associated with the brands, target audience demographics, advertising campaign goals, ownership attributes, and/or other suitable attributes. The attributes may be stored in the database 214 to which the resonance estimator 222 is communicatively coupled.

In some examples, to determine the subject resonance measurement with respect to the first stimulus 302, the resonance estimator 222 places the respective first DERP measurement 324 on a relative scale. For example, the first DERP measurement 324 may be calculated in response to the presentation of the word “healthy” (e.g., the word 315) before and after exposure of the subject to the master brand Coca-Cola® (e.g., the first stimulus 302). The resonance estimator 222 may convert the value of the first DERP measurement to a relative value on a scale of, for example, 0-10, where 0 corresponds to substantially no association between the word “healthy” and the master brand CocaCola®, 5 corresponds to a moderate association between the word and the master brand before and after viewing the word “healthy” and the master brand CocaCola®, and 10 corresponds to a substantially strong association between the word “healthy” and Coca-Cola®. In some examples, the resonance estimator 222 assigns the first DERP measurement 324 a value on the relative scale based on, for example, degree of the difference between the first ERP measurement 316 and the second ERP measurement 318.

For example, the first ERP measurement 316 reflects the subject's response to the word “healthy” prior to exposure to the master brand CocaCola®. The second ERP measurement 318 reflects the subject's response to the word “healthy” after exposure to the master brand Coca-Cola®. Referring to the example ERP waveforms of FIG. 4 described above, the first DERP measurement 324 may have a value of +1.03 μV based on the amplitude difference between the first ERP component 402 and the second ERP component 404. The resonance estimator 222 may evaluate the value of the first DERP measurement 324 against criteria (which may be predetermined or adjusted in response to communications) to assign the first DERP measurement a value on the scale. Example criteria includes expected results, desired results, historical data, a threshold absolute value of change and/or other parameter(s) or metric(s) set by an entity conducting the testing, an entity analyzing the results, and/or an entity requesting the testing. For example, based on the criteria, amplitude differences between the first and second ERP components that fall within a range of +1.00-1.10 μV may be associated with little to no word association with the stimulus. Thus, in the example described, the resonance estimator 222 may convert or assign the first DERP 324 value of +1.03 μV to a value of 2 on the relative scale, thereby indicating that the subject does not strongly associate the master brand Coca-Cola®with the word “healthy.” In these examples, the subject resonance measurement estimated by the resonance estimator 222 may reflect the subject's perception of the master brand.

In some examples, the DERP measurements are not converted to a relative scale but, rather, the absolute (e.g., the converted) values are used in the comparison. However, the converted scale is more intuitive and facilitates analysis of the results by readily identifying changes in resonance and perception. ERP components are measured in micro-volts and changes that may initially appear small and insignificant on the micro-scale could actually represent large changes in terms of a consumer's mental state and perception.

The resonance estimator 222 of the illustrated example determines a subject's resonance to a respective stimulus (e.g., the sub-brand advertisement, the master brand) and/or across stimuli (e.g., resonance to the master brand in view of the sub-brand) using the collected neuro-response data. The cross-stimulus resonance assessment indicates how exposure to the sub-brand (e.g., the second stimulus 304) affects subject perception of the master brand (e.g., the third stimulus 306). The example resonance estimator 222 of the illustrated example estimates the subject resonance to the master brand after exposure to the sub-brand and/or sub-brand advertisement based on the second DERP 326 of FIG. 3. For example, the resonance estimator 222 may assess the subject's association of the work “healthy” with the master brand Coca-Cola® after exposure to the sub-brand Coca-Cola Zero®. The resonance estimator 222 of the illustrated example assigns the second DERP measurement 326 a value on the relative scale in the same manner as described with respect to the first DERP measurement 324. For instance, referring to the example FIG. 4, the second DERP measurement 326 has a value of +1.42 μV based on the amplitude difference between the example third ERP component 406 of FIG. 4 having a peak amplitude of +3.55 μV and the example fourth ERP component 408 having a peak amplitude of +4.97 μV. Based on the degree of the differential between the third ERP measurement 320 and the fourth ERP measurement 322, the resonance estimator 222 of the illustrated example assigns the second DERP 326 a value on the relative scale. For example, using the criteria, the resonance estimator 222 may determine that DERP measurements having a value in the range of +1.40-1.50 μV reflect a stronger word-stimulus association than DERP values that fall below that range. Thus, the resonance estimator may convert the third DERP measurement of +1.42 μV to a value of 7 on the relative scale, thereby reflecting an association of the master brand Coca-Cola® with the word “healthy” in the mind of the subject. Thus, the subject resonance measurement estimated by the resonance estimator 222 of the illustrated example reflects the subject's perception of the master brand after exposure to the sub-brand (e.g., the second stimulus 304). In the example of FIG. 3, the subject resonance levels determined by the resonance estimator 222 can be stored in the database 214. To this end, the resonance estimator 222 is communicatively coupled to the database 214.

In some examples, the resonance estimator 222 evaluates the third DERP 328 to determine a subject resonance to the second stimulus (e.g., the sub-brand Coca-Cola Zero®). In such examples, the third DERP 328 provides an indication of the degree to which the second stimulus communicates the concept or idea reflected in the word 315. For example, the differential between the second ERP measurement 318 and the third ERP measurement 320 may indicate the degree to which the sub-brand Coca-Cola Zero® is communicating the concept of “healthy” to the subject. In the illustrated example, the third DERP measurement 328, thus, provides an indication of the subject resonance to the second stimulus 304, which may be evaluated independently of the first stimulus 302 and/or the third stimulus 304. For example, whereas the second DERP measurement 326 may reflect the subject resonance to the master brand after exposure to the sub-brand (e.g., the second stimulus 304), the third DERP measurement 328 may be viewed as representative of the subject resonance to the sub-brand independent of the subject resonance to the master brand. Thus, the resonance estimator 222 of the illustrated example assesses the first, second, and third DERPs 324, 326, 328 respectively to provide subject resonance measurements. Referring to the example of FIG. 4, the third DERP measurement 328 has a value of +1.51 μV, which may be converted by the resonance estimator 222 to a value of 8 on the relative scale, thereby indicating a relatively strong association between the word “healthy” and the sub-brand Coca-Cola Zero®. Thus, based on the placement of the third DERP measurement 328 on the scale, an entity such as The Coca-Cola Company that sponsors an advertising campaign can evaluate whether the advertising campaign is having intended and/or unintended impacts on the subject's perception of the brand to which the advertising campaign is directed. For example, The Coca-Cola Company may determine that, based on the third DERP measurement 328 having a value of 8 on the scale, the advertising campaign directed toward the health aspects of Coca-Cola Zero®(e.g., zero calories) is effective in influencing the subject to associate the word “healthy” with Coca-Cola Zero®

In the illustrated example, the data analyzer 218 includes a comparer 224 to determine a change in the subject resonance to a stimulus based on exposure to other stimuli. For example, the comparer 224 may determine a change in the subject resonance to the master brand after exposure to the sub-brand and/or the sub-brand advertisement. To evaluate the change in the subject resonance to one or more stimuli, the comparer 224 evaluates the DERP measurements derived by the calculator 220 and analyzed by the resonance estimator 222.

As an example, in reference to FIG. 3, the first stimulus 302 and the third stimulus 306 are the master brand Coca-Cola® and the second stimulus 304 is an advertisement for the sub-brand Coca-Cola Zero® to assess the association of the word “healthy” with master brand in view of the sub-brand advertising. As described above, the data collector 202 of the illustrated example collects neuro-response data before the subject is exposed to the master brand (e.g., at time t₁ of FIG. 3) and after the subject is exposed to the master brand, but before the subject is exposed to the sub-brand advertisement (e.g., at time t₃). The example data collector(s) 202 also collect neuro-response data after the subject is exposed to the sub-brand advertisement (e.g., at time t₅). In addition, the example data collector(s) 202 may collect neuro-response data after the subject has been re-exposed to the master brand and/or after the subject is exposed to a brand sharing an attribute with the master brand, and after being exposed to the sub-brand advertisement (e.g., at time t₇). For example, the brand sharing an attribute with the master brand may include a brand for a similar product and/or service as the master brand (e.g., Pepsi®).

The example data analyzer 218 of FIG. 2, including the example calculator 220 and/or the example resonance estimator 222, determines a subject's resonance to (1) the master brand prior to exposure to the sub-brand advertisement (e.g., the first DERP 324); (2) the master brand and/or the brand sharing an attribute with the master brand, and after exposure to the sub-brand advertisement (e.g., the second DERP 326), and, in some examples, (3) the sub-brand advertisement (e.g., the third DERP 328). As disclosed above, the subject's resonance may be based on, for example, the DERP measurements 324, 326, 328 indicative of subject attention, emotion, and/or memory retention associated with the one or more stimuli and reflective of an implicit and/or explicit association by the subject of the word “healthy” with the one or more stimuli.

The comparer 124 of the illustrated example further analyzes the DERP measurements 324, 326, 328 to detect a change in subject resonance to the master brand (e.g., Coca-Cola®) as a result of, for example, exposure to the sub-brand advertisement (e.g., the advertisement for Coca-Cola Zero®). For instance, in the example described above, the first DERP measurement 324 is determined based on the neuro-response data collected pre- and post-exposure to the master brand and prior to exposure to the sub-brand advertisement (e.g., the first ERP 316 and the second ERP 318, and, in particular, the first ERP component 402 and the second ERP component 404). Also as described above, the example resonance estimator 222 of FIG. 2 assigns a value to the first DERP measurement 324 on a relative scale reflecting a degree to which the subject associates the word “healthy” with the master brand (e.g., a value of 2). The second DERP measurement 326 is determined based on neuro-response data collected post-exposure to the sub-brand advertisement (e.g., the third ERP 320) and post-re-exposure to the master brand and/or post-exposure to a brand sharing an attribute with the master brand (e.g., the fourth ERP 322). The resonance estimator 222 of the illustrated example assigns a value to the second DERP measurement 326 on the relative scale (e.g., a value of 7) reflecting an association of the master brand with the word “healthy” after exposure to the sub-brand.

To assess the change in the subject resonance to the master brand due to exposure to the sub-brand advertisement, the example comparer 224 of FIG. 2 compares the values assigned to the first and second DERP measurements 324, 326 to detect a change (or lack thereof) in the subject resonance to the master brand prior to and after exposure to the sub-brand advertisement at time t₄. For example, the comparer 224 in the illustrated example compares the value of 2 assigned to the first DERP measurement 324 and the value of 7 assigned to the second DERP measurement 326. The example comparer 224 of FIG. 2 detects an increase in the value of the second DERP measurement 326 after exposure to advertisement for Coca-Cola Zero®.

Referring to the relative scale of 0-10, where 0 corresponds to substantially no word-brand association, 5 corresponds to moderate word-brand association, and 10 corresponds to a strong word-brand association, the example comparer 224 detects that prior to exposure to the sub-brand, the subject's association between “healthy” and Coca-Cola® as represented by the first DERP measurement 324 was closer to 0 on the scale (e.g., a value of 2), thereby indicating little word-brand association. The example comparer 224 of the illustrated example detects that after exposure to the advertisement for Coca-Cola Zero®, the subject's association between “healthy” and Coca-Cola® as represented by the second DERP measurement 326 was closer to 10 on the scale (e.g., a value of 7), thereby indicating strong word-brand association. Thus, the example comparer 224 of FIG. 2 determines that the Coca-Cola Zero® affected how the subject perceives the master brand Coca-Cola® by increasing the association of the master brand with the concept of “healthy”. In particular, the example comparer 224 in this example detects that the advertisement for Coca-Cola Zero® has increased the subject's association between “healthy” and the master brand CocaCola®, such that the subject's perception of Coca-Cola® is one of being more associated with the concept of “healthy” than not based on the relative scale.

In other examples, the example comparer 224 detects that the value of the second DERP 326 has decreased and/or has remained the same as compared to the value of the first DERP 324 on the relative scale. In some examples, the comparison of the first DERP 324 and the second DERP 326 represents a positive effect of the sub-brand on the master brand (e.g., increasing the perception of Coca-Cola® as associated with “healthy”), a negative effect (e.g., resulting in a decreased association of Coca-Cola® with “fun” in view of the health-oriented advertising campaign for Coca-Cola Zero®), or substantially no discernable effect. In such a manner, the change detected by the comparer 224 of the illustrated example based on the comparison of DERP measurements may provide an indication of an effect and/or impact of the sub-brand and/or sub-brand advertisement on the master brand.

In some examples, one or more of the example resonance estimator 222 or the example comparer 224 determines the effectiveness of the sub-brand and/or the sub-brand advertising (e.g., the second stimulus 304) in affecting the subject's perception of, for example, the master brand, based on the change between the first DERP 324 and the second DERP 326. For example, an entity such as The Coca-Cola Company may seek to increase consumers' perceptions of the master brand Coca-Cola® as being associated with healthy drink choices. Thus, The Coca-Cola Company may implement an advertising campaign directed toward Coca-Cola Zero® advertising, for example, the drink's low calorie count. Using the example process 300, the resonance estimator 222 and the comparer 224 may evaluate the first and second DERP measurements 324, 326 to determine a change in consumer association between Coca-Cola® and “healthy”. The degree of the change as determined based on the comparison of the first and second DERP measurements 324, 326 may reflect an effectiveness of the Cola-Cola Zero® advertising campaign in changing how consumers think about Coca-Cola® with respect to the concept of “healthy”. In other examples, the resonance estimator 222 and/or the comparer 224 assess unintentional effects of the Cola-Cola Zero® advertising campaign, such as a decrease in the consumer's perception of the master brand Coca-Cola® as associated with the concept of “fun”. Thus, the example process 300 as implemented by the example system 200 provides for assessment of the intentional and/or unintentional effects of the sub-brand and/or the sub-brand advertising on the master brand.

While an example manner of implementing the example system 200 is illustrated in FIG. 2, one or more of the elements, processes and/or devices illustrated in FIG. 2 may be combined, divided, re-arranged, omitted, eliminated and/or implemented in any other way. Further, the example data collector(s) 202, the database 214, the data analyzer 218, the calculator 220, the resonance estimator 222, the comparer 224, and/or, more generally, the example system 200 of FIG. 2 may be implemented by hardware, software, firmware and/or any combination of hardware, software and/or firmware. Thus, for example, any of the example data collector(s) 202, the database 214, the data analyzer 218, the calculator 220, the resonance estimator 222, the comparer 224, and/or, more generally, the example system 200 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, data collector(s) 202, the database 214, the data analyzer 218, the calculator 220, the resonance estimator 222, the comparer 224, and/or, more generally, the example system 200 of FIG. 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example system 200 of FIG. 2 may include one or more elements, processes and/or devices in addition to, or instead of, those illustrated in FIG. 2, and/or may include more than one of any or all of the illustrated elements, processes and devices.

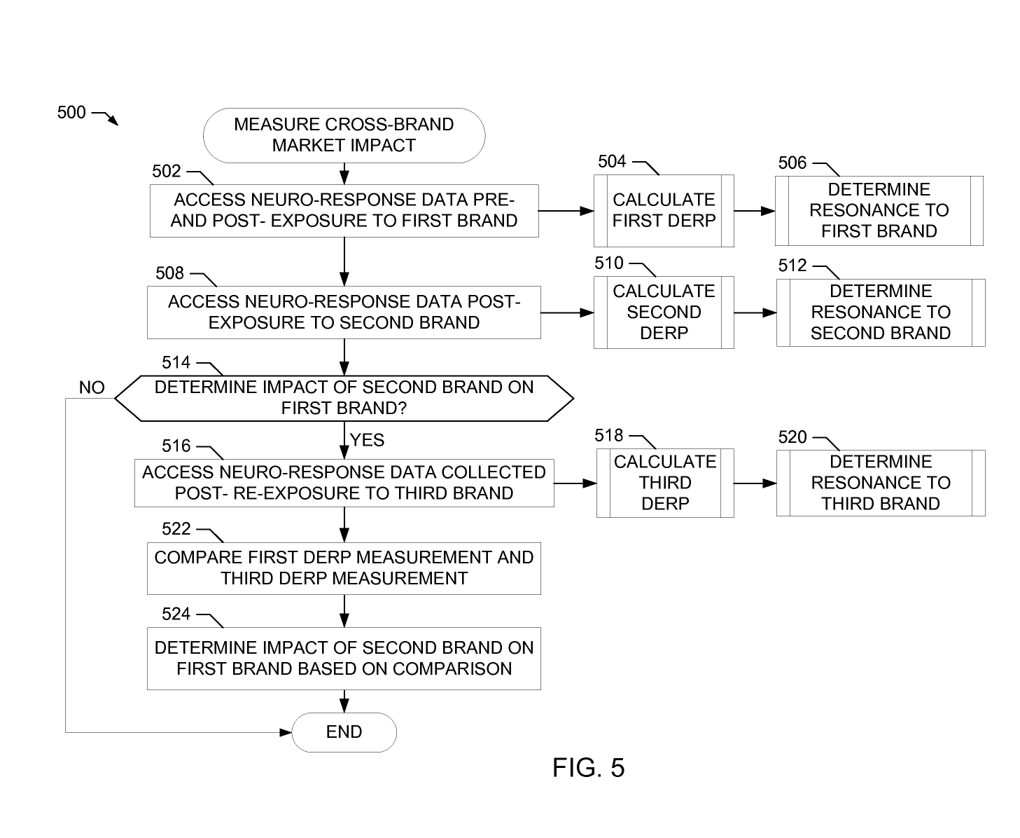

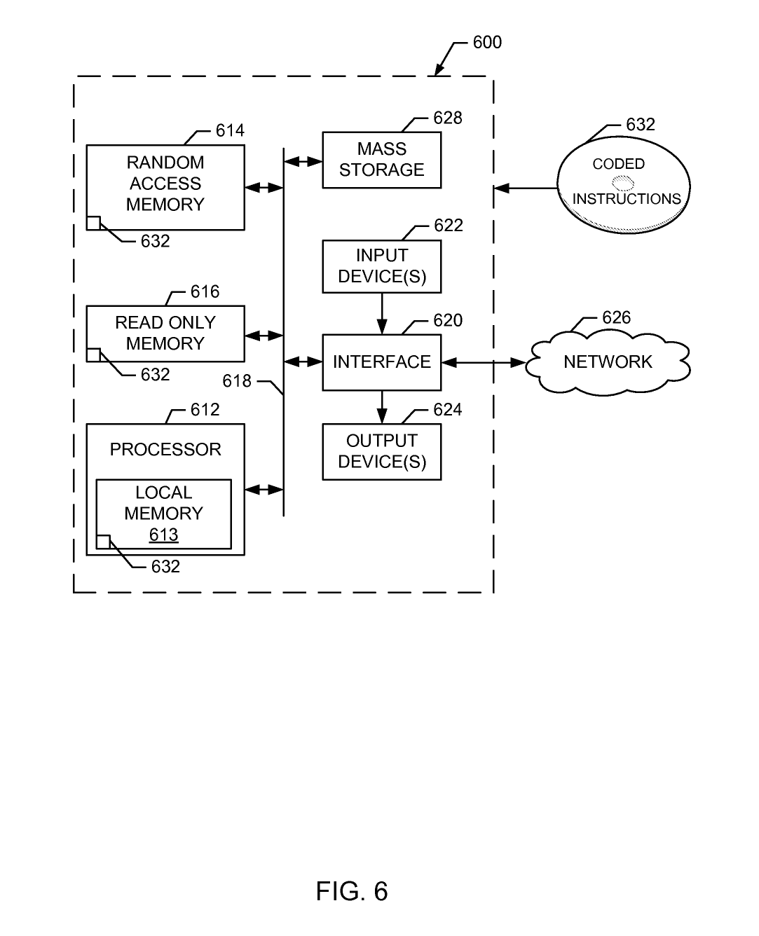

A flowchart representative of example machine readable instructions for implementing the example system 200 of FIG. 2 is shown in FIG. 5. In this example, the machine readable instructions comprise a program for execution by a processor such as the processor 612 shown in the example processor platform 600 discussed below in connection with FIG. 6. The program may be embodied in software stored on a tangible computer readable storage medium such as a CD-ROM, a floppy disk, a hard drive, a digital versatile disk (DVD), a Blu-ray disk, or a memory associated with the processor 612, but the entire program and/or parts thereof could alternatively be executed by a device other than the processor 612 and/or embodied in firmware or dedicated hardware. Further, although the example program is described with reference to the flowchart illustrated in FIG. 5, many other methods of implementing the example system 200 may alternatively be used. For example, the order of execution of the blocks may be changed, and/or some of the blocks described may be changed, eliminated, or combined.

As mentioned above, the example processes of FIG. 5 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIG. 5 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 5 illustrates example instructions 500 which may be executed to measure cross-brand market impact. The example instructions 500 cause a machine to access neuro-response data obtained from a subject, such as a consumer, before exposure to a first brand and after exposure to the first brand (block 502). For example, the neuro-response data may be collected using a plurality of modalities, such as the data collector(s) 202 of FIG. 2. In some examples, the collected neuro-response data is one or more the EEG data 204, the EOG data 206, the fMRI data 208, the EMG 210, and/or the facial expression data 212. In some examples, the first brand is a master brand, as described above in connection with FIGS. 1-3. Also as described above, in some examples, the neuro-response data is collected during the presentation of a word representative of a concept that may or may not be associated with the first brand (e.g., the word 315 of FIG. 3). The word may be presented one or more times before and after exposure to the first brand.

With respect to the neuro-response data collected at block 502, the example instructions 500 cause a machine to calculate a first differential event related potential (DERP) measurement (block 504), using for example, the example data analyzer 218 and/or the calculator 220 of FIG. 2. For example, the data analyzer 218, via the example calculator 220, may calculate event related potential (ERP) measurements based on the neuro-response data collected pre- and post-exposure to the first brand. Using the ERP measurements, the calculator 220 calculates the first DERP measurement. In some examples raw neuro-response data or neuro-response data that has been amplified and filtered is accessed at block 402, and the calculator 220 calculates the ERP measurements upon which the DERP measurements throughout this example are based.

The example instructions 500 cause a machine to determine a subject resonance to the first brand based on the neuro-response data (block 506), using, for example, the example resonance estimator 222 of FIG. 2. For example, the resonance estimator 222 associated with the data analyzer 218 may determine the subject resonance to the first brand based on the first DERP measurement. In some examples, the resonance estimator 224 assigns a value to the first DERP measurement on a relative scale. In some examples, the subject resonance obtained for the first brand may be representative of, for example, a consumer's initial perception of the master brand, prior to, for example, exposure to another brand, such as a sub-brand.

The example instructions 500 also cause a machine to access neuro-response obtained from the subject after exposure to a second brand (block 508). In some examples, the second brand is associated with the first brand based on one or more attributes. For example, the first brand and the second brand may be owned by a common entity. In other examples, the second brand may be a sub-brand of the first brand, or master brand. Also, in some examples, neuro-response data accessed at block 508 is collected from exposure of the subject to an advertisement for the second brand, a specimen associated with the second brand (e.g., a physical product), and/or any other stimulus associated with the second brand. As described above, the neuro-response data obtained after exposure to the second brand, the advertisement for the second brand, or the stimulus associated with the second brand may be collected using the data collector(s) 202 of FIG. 2.

The example instructions 500 cause a machine to calculate a second DERP measurement (block 510) in association with the second brand using, for example, the calculator 220. For example, the calculator 220 calculates the second DERP measurement using the neuro-response data obtained from the subject after exposure to the first brand (block 502) and the neuro-response data obtained from the subject after exposure to the second brand (block 508). As noted above, in some examples, the neuro-response data collected before and after the subject's exposure to the first brand (e.g., the master brand) may be used to determine the subject's perception of the first brand prior to exposure to the second brand (e.g., the sub-brand) and/or the advertisement for the second brand. In some examples, the neuro-response data collected after exposure to the first brand but before exposure to the second brand may be used in determining the subject resonance to the first brand as well as the second brand (e.g., the neuro-response data is treated as the post-first brand exposure data as well as the pre-second brand exposure data). Thus, using the example instructions 500, neuro-response data may be collected and analyzed across brands. The second DERP measurement may be calculated by the example data analyzer 218 of FIG. 2.

The example instructions 500 cause a machine to determine the subject resonance to the second brand based on the second DERP measurement (block 512). The subject resonance to the second brand is determined by, for example, the example resonance estimator 222 of FIG. 2. In some examples, the subject resonance is determined for an advertisement of the second brand and the resonance measurement indicates an effectiveness of the advertisement. For example, the second DERP measurement may be used to assess the impact of the advertisement on the subject's perception of the second brand and/or attributes associated with the second brand.

The example instructions 500 cause a machine to evaluate subject resonance to the first brand (block 506) and the second brand (block 512) using shared neuro-response data collected after exposure to the first brand but before exposure to the advertisement and/or the second brand. In some examples, a decision is made to determine the impact of second brand on the first brand (block 514). For example, in examples where the first brand is a master brand and the second brand is a sub-brand of the master brand, the example instructions 500 cause a machine to determine the impact of the sub-brand on the master brand, using, for example, the comparer 224 of FIG. 2. In other examples, where an advertisement for the sub-brand is presented to the subject (block 508), the example instructions 500 cause a machine to determine the impact of the advertisement for the sub-brand on the master brand.

The example instructions 500 cause a machine to access neuro-response data collected after the subject is exposed to a third brand (block 516). In some examples, the third brand shares one or more attributes and/or components with the first brand. For example, the first brand may be a first master brand associated with a first product and the third brand may be a second master brand associated with the first product. In some examples, the first brand is a master brand and the third brand is a portfolio of brands of which the first brand is a member. In other examples, the first brand, the second brand, and the third brand are sub-brands commonly associated with one or more products and/or services. In other examples, the first brand and the third brand are the same brand. In such examples, the neuro-response data collected at block 516 includes data collected after the subject has been re-exposed to the first brand after exposure to the advertisement for the second brand. As described above, the neuro-response data obtained after exposure to the third brand may be collected using the data collector(s) 202 of FIG. 2. Also as described above, in some examples, the neuro-response data is collected during the presentation of the word representative of a concept that may or may not be associated with the first brand (e.g., the word 315 of FIG. 3). The word may be presented one or more times before and after exposure to the third brand.

The example instructions 500 cause a machine to calculate a third DERP measurement based on the neuro-response data obtained after exposure to the third brand (block 518) using, for example, the data analyzer 218 and/or the calculator 220 of FIG. 2. For example, the calculator 220 calculates the third DERP measurement using the neuro-response data obtained from the subject after exposure to the second brand (block 508) and the neuro-response data obtained from the subject after exposure to the third brand (block 516). In some examples, the example resonance estimator 222 of FIG. 2 uses the neuro-response data collected after exposure to the second brand but before exposure to the third brand to determine the subject resonance to the second brand as well as the third brand (e.g., the neuro-response data is treated as the post-second brand exposure data as well as the pre-third brand exposure data). At block 520, the resonance estimator 222 determines the subject resonance to the third brand based on the third DERP measurement. As described above, in some examples, the third brand is associated with the first brand (e.g., via one or more shared components or attributes). Also as described above, the subject resonance for the third brand is based on the third DERP measurement, which is calculated by the example calculator 220 using neuro-response data collected after the subject is exposed to the second brand. In such examples, the subject resonance to the third brand may be representative of, for example, a consumer's perception of the first brand after being exposed to the second brand (e.g., the consumer's association of a concept such as “healthy” with the first brand after being exposed to the second brand).

The example instructions 500 cause a machine to determine the subject resonance to the first brand prior to exposure to the second brand using the first DERP measurement (block 506) and the subject resonance to the third brand, after exposure to the second brand using the third DERP measurement (block 520) using, for example, the example resonance estimator 222 of FIG. 2. In the example instructions 500 cause a machine to compare the first DERP measurement and the third DERP measurement (block 522) to determine the impact of the second brand on the first brand (block 524). For example, the example comparer 224 compares the values assigned to the first DERP measurement and the second DERP measurement on the relative scale by the resonance estimator 222 to (1) detect if there is change in subject resonance to the first brand after exposure to the second brand and (2) determine the degree or extent to which the subject resonance has changed. Such analysis may provide for indications of, for example, changes in a subject's perception(s) of the first brand after exposure to the second brand. Such changes in the subject's perception(s) can include, for example, a degree to which the subject associates the first brand with one or more concepts, whether the subject has a more/less favorable impression of the first brand after exposure to the second brand and/or whether the subject is aware of the first brand and/or the second brand after exposure to the second brand. In other examples, the analysis provide insights into whether the subject's perception(s) of the first brand have changed after exposure to an advertisement for the second brand or a product associated with the second brand. In such a manner, the example instructions 500 may be executed to measure the cross-brand market impact of advertising for the second brand on the first brand while also determining the impact of, for example, the advertising on the second brand.

As disclosed above, in some examples, the first brand includes a master brand and the second brand includes a sub-brand of the master brand. However, the example instructions 500 may also be executed using neuro-response data collected from exposure of the subject to brand relationships other than the master brand/sub-brand relationship and/or the master brand/sub-brand advertisement relationship. For example, the first brand and/or third brand may be a portfolio of brands, including one or more master brands and/or sub-brands, owned by a first entity. In other examples, the first brand is a master brand and/or sub-brand owned by a second entity, such as a competitor of the first entity, and the second brand is a master and/or sub-brand owned by the first entity. In such examples, the example instructions 500 cause a machine to measure the cross-brand market impact of the advertisement for the first entity's master and/or sub-brand on the competitor's master brand and/or sub-brand. In other examples, the example instructions 500 are implemented using neuro-response data related to exposure to marketing for the brands, rather than the brands themselves. For example, the first brand and the third brand may be a logo for the master brand and the second brand may be an advertisement for the master brand. Other combinations of brand relationships for the first brand, second brand, and/or third brand may be included in implementation(s) of the example instructions 500. As described above, the example instructions 500 cause a machine to measure the market impact of a brand and/or advertisement for a brand within a brand, across other brands owned by the same entity, and/or across brands owned by different entities. Further, the example instructions 500 can be executed to cause a machine to measure the response data collected from multiple subjects to evaluate the cross-brand impact across a group of subjects.

FIG. 6 is a block diagram of an example processor platform 600 capable of executing the instructions of FIG. 5 to implement the example system 200 of FIG. 2. The processor platform 600 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 600 of the illustrated example includes a processor 612. The processor 612 of the illustrated example is hardware. For example, the processor 612 can be implemented by one or more integrated circuits, logic circuits, microprocessors or controllers from any desired family or manufacturer.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes an interface circuit 620. The interface circuit 620 may be implemented by any type of interface standard, such as an Ethernet interface, a universal serial bus (USB), and/or a PCI express interface.

In the illustrated example, one or more input devices 622 are connected to the interface circuit 620. The input device(s) 622 permit(s) a user to enter data and commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 620 of the illustrated example, thus, typically includes a graphics driver card, a graphics driver chip or a graphics driver processor.

The interface circuit 620 of the illustrated example also includes a communication device such as a transmitter, a receiver, a transceiver, a modem and/or network interface card to facilitate exchange of data with external machines (e.g., computing devices of any kind) via a network 626 (e.g., an Ethernet connection, a digital subscriber line (DSL), a telephone line, coaxial cable, a cellular telephone system, etc.).

The processor platform 600 of the illustrated example also includes one or more mass storage devices 628 for storing software and/or data. Examples of such mass storage devices 628 include floppy disk drives, hard drive disks, compact disk drives, Blu-ray disk drives, RAID systems, and digital versatile disk (DVD) drives.

The coded instructions 632 of FIG. 6 may correspond to the instructions of FIG. 5 and may be stored in the mass storage device 628, in the volatile memory 614, in the non-volatile memory 616, and/or on a removable tangible computer readable storage medium such as a CD or DVD.

From the foregoing, it will be appreciated that methods, systems, and machine readable storage media have been disclosed which provide for analysis of an impact of an advertisement for a master and/or sub-brand owned by an entity on the master and/or sub-brand itself, across other master and/or sub-brands owned by the entity, and/or across master and/or sub-brands owned by a different entity. In particular, the examples disclosed herein use neuro-response data collected from subjects exposed to an advertisement to derive implicit perceptions of master and/or sub-brands and/or advertisements for master and/or sub-brands as well as to detect changes in the implicit perceptions of the master and/or sub-brands. In some examples, the implicit perceptions are representative of associations between abstract concepts and the master and/or sub-brands in the minds of consumers. Disclosed examples measure an impact of an advertisement for a master and/or sub-brand on the master and/or sub-brand itself based on neuro-response data obtained before and after exposure to the advertisement. Further, the examples disclosed herein extend the analysis of the advertisement impact to account for the influence of the advertisement on a consumer's perception of a another master and/or other sub-brand associated with the master and/or sub-brand that is the subject of the advertisement. In such a manner, the examples disclosed herein provide for detection of intended and/or unintended impacts of a marketing campaign on consumer perceptions of a brand, one or more related brands, and/or one or more competitor master and/or sub-brands. The analysis described herein may be used across a variety of brand relationships, including, for example, between a master brand and a sub-brand owned by a first entity, between a first sub-brand and a second sub-brand owned by the first entity, between a first master brand and a second master brand owned by the first entity, and/or between a master and/or sub-brand owned by a first entity and a master and/or sub-brand owned by a second entity (e.g., a competitor), Thus, disclosed examples account for the reaching impact of a marketing campaign for a brand on consumer brand perceptions in the marketplace. Further, examples disclosed herein are not limited to assessing the impact of a marketing campaign for a master and/or sub-brand, but may also be used to evaluate the impact of the master and/or sub-brand itself, a product associated with the master and/or sub-brand, and/or other master and/or sub-brand stimuli that may have a cross-brand impact on consumer perception.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
accessing first neuro-response data obtained from a subject prior to exposure to a first stimulus having a first component, second neuro-response data obtained from the subject after exposure to the first stimulus and prior to exposure to a second stimulus, third neuro-response data obtained from the subject after exposure to the second stimulus, and fourth neuro-response data obtained from the subject after exposure to a third stimulus having the first component; and
determining, using a processor, a change in a subject resonance to the first component based on a comparison of a first difference between the first neuro-response data and the second neuro-response data relative to a second difference between the third neuro-response data and the fourth neuro-response data.

2. The method of claim 1, wherein the first stimulus and the third stimulus are identical.

3. The method of claim 1, wherein the first difference is
a first differential event related potential measurement and the second difference is a second differential event related potential.

4. The method of claim 3, further comprising
determining at least one of a subject resonance to the first stimulus based on the first differential event related potential measurement or a subject resonance to the third stimulus based on the second differential event related potential measurement.

5. The method of claim 4, wherein the change in the subject resonance to the first component is based on a comparison of the first differential event related potential relative to the second differential event related potential.

6. The method of claim 1, further comprising
calculating a third difference between the second neuro-response data and the third neuro-response data; and
determining a subject resonance to the second stimulus based on the third difference.

7. The method of claim 1, further comprising determining an effect of the second stimulus material with respect to the first component based on the change.

8. The method of claim 1, wherein the first component is a master brand and the second stimulus includes a sub-brand, the master brand and the sub-brand owned by a same entity.

9. The method of claim 1, wherein the first component is a first brand for a first entity and the second stimulus includes a second brand for a second entity.

10. A system comprising:
an analyzer to analyze first neuro-response data obtained from a subject prior to exposure to a first stimulus having a first component, second neuro-response data obtained from the subject after exposure to the first stimulus and prior to exposure to a second stimulus, third neuro-response data obtained from the subject after exposure to the second stimulus, and fourth neuro-response data obtained from the subject after exposure to a third stimulus having the first component;
a calculator to calculate a first difference between the first neuro-response data and the second neuro-response data and a second difference between the third neuro-response data and the fourth neuro-response data;
a comparer to compare the first difference and the second difference to determine a change in a subject resonance to the first component.

11. The system of claim 10, wherein the first stimulus and the third stimulus are identical.

12. The system of claim 10, wherein the first difference is a first differential event related potential measurement and further comprising a resonance estimator to determine a subject resonance to the first stimulus based on the first differential event related potential measurement.

13. The system of claim 12, wherein the second difference is a second differential event related potential measurement, and the resonance estimator is to determine a subject resonance to the third stimulus based on the second differential event related potential measurement.

14. The system of claim 13, wherein the comparer is to compare the first differential event related potential and the second differential event related potential and the resonance estimator is to determine the change in the subject resonance to the first component based on the comparison of the first differential event related potential relative to the second differential event related potential.

15. The system of claim 10, wherein the calculator is to calculate a third difference on the second neuro-response data and the third neuro-response data, and the resonance estimator is to determine a subject resonance to the second stimulus based on the third difference.

16. The system of claim 10, wherein the resonance estimator is to determine an effect of the second stimulus material with respect to the first component based on the change.

17. The system of claim 10, wherein the first component is a master brand and the second stimulus includes a sub-brand, the master brand and the sub-brand owned by a same entity.

18. A machine readable storage device or storage medium comprising instructions, which, when read, cause a machine to at least:
access first neuro-response data obtained from a subject prior to exposure to a first stimulus having a first component, second neuro-response data obtained from the subject after exposure to the first stimulus and prior to exposure to a second stimulus, third neuro-response data obtained from the subject after exposure to the second stimulus, and fourth neuro-response data obtained from the subject after exposure to a third stimulus having the first component; and
determine a change in a subject resonance to the first component based on a comparison of a first difference between the first neuro-response data and the second neuro-response data relative to a second difference between the third neuro-response data and the fourth neuro-response data.

19. The machine readable storage medium of claim 18, wherein the first difference is
a first differential event related potential measurement and the second difference is a second differential event related potential measurement and wherein the instructions further cause the machine to determine a subject resonance to the first stimulus based on the first differential event related potential measurement and determine a subject resonance to the third stimulus based on the second differential event related potential measurement.

20. The machine readable storage medium of claim 19, wherein the instructions further cause the machine to:
compare the first differential event related potential and the second differential event related potential; and
determine the change in the subject resonance to the first component based on the comparison of the first differential event related potential relative to the second differential event related potential.

21. The machine readable storage medium of claim 18, wherein the instructions further cause the machine to:
calculate a third difference between the second neuro-response data and the third neuro-response data; and
determine a subject resonance to the second stimulus based on the third difference.

22. The machine readable storage medium of claim 18, wherein the first stimulus and the third stimulus are identical.

23. The machine readable storage medium of claim 18, wherein the instructions further cause the machine to determine an effect of the second stimulus material with respect to the first component based on the change.

24. The machine readable storage medium of claim 18, wherein the first component is a master brand and the second stimulus includes a sub-brand, the master brand and the sub-brand owned by a same entity.

25. The machine readable storage medium of claim 18, wherein the first component is a first brand for a first entity and the second stimulus includes a second brand for a second entity.

26. A method comprising:
accessing first neuro-response data obtained from a subject prior to exposure to a first brand, second neuro-response data obtained from the subject after exposure to the first brand and prior to exposure to a second brand, third neuro-response data obtained from the subject after exposure to the second brand, and fourth neuro-response data obtained from the subject after exposure to the first brand and after exposure to the second brand, wherein the second brand shares an attribute with the first brand; and
determining, using a processor, a change in a subject resonance to the first brand based on a comparison of a first difference between the first neuro-response data and the second neuro-response data relative to a second difference between the third neuro-response data and the fourth neuro-response data.

27. The method of claim 26, wherein the attribute is at least one of ownership, a product offering, a service offering, a packaging, a price, or an advertisement.

28. The method of claim 26, wherein the first brand is owned by a first entity and the second brand is owned by a second entity.

29. The method of claim 26, wherein the first brand is a master brand and the second brand includes a sub-brand, the master brand and the sub-brand owned by a same entity.

30. The method of claim 26, wherein the first brand is a master brand and the second brand is a sub-brand presented in an advertisement, the master brand and the sub-brand owned by a same entity.

31. The method of claim 26, further comprising determining an effect of the second brand with respect to the first brand based on the change.

32. The method of claim 26, wherein the change is indicative of a difference in a first association between the first brand and a characteristic and a second association between the first brand and the characteristic.

33. The method of claim 26, wherein the first difference is a first differential event related potential measurement and the second difference is a second differential event related potential measurement.

34. The method of claim 33, wherein the change to the subject resonance is based on a comparison of the first differential event related potential relative to the second differential event related potential.
